(19) United States
(12) Patent Application Publication
(10) Pub. No.: US 2023/0177930 A1
(43) Pub. Date: Jun. 8, 2023

(54) PASSAGEWAY SYSTEM

(71) Applicant: Martin EBERLEIN, Sofia (BG)

(72) Inventor: Martin EBERLEIN, Sofia (BG)

(21) Appl. No.: 17/923,939

(22) PCT Filed: May 8, 2021
(86) PCT No.: PCT/DE2021/000085

§ 371 Date: Nov. 8, 2022

(30) Foreign Application Priority Data
May 14, 2020 (DE) 10 2020 002 894.2

(51) Int. Cl. G07G 1/00; G07C 9/10

(52) U.S. Cl. CPC G07G 1/009; G07C 9/10

(57) ABSTRACT

The invention relates to a passageway system with at least one foot element, with at least one blocking element which is mounted on the foot element and which is movable between at least one blocking position intended for at least partially blocking a passage and at least one release position releasing the passage, with a drive unit serving to move the at least one blocking element with a control of the drive unit, with a detection unit intended for the identifying detection of goods, and with interfaces to a data processing unit and optionally further components.

The invention is characterized in that at least one optical detection device is arranged on the at least one blocking element and is a component of the detection unit.

The invention relates to a passageway system with at least one foot element, with at least one blocking element which is mounted on the foot element and which is movable between at least one blocking position intended for at least partially blocking a passage and at least one release position releasing the passage, with a drive unit serving to move the at least one blocking element, with a control of the drive unit, with a detection unit intended for the identifying detection of goods, and with interfaces to a data processing unit and optionally further components.

Passageway systems with a foot element and a movable blocking element are described, among others, in DE 25 48 069 A1, DE 40 37 796 A1, and DE 201 11 709 U1, EP 2 184 435 A1, and EP 2 717 235 A1. It is known to arrange such passageway systems in pairs next to each other or also behind each other and to have them open and close in a coordinated manner with the aid of a control system. The foot element of a passageway system in operation is fixed to the floor and laterally delimits a passageway. In the blocking position intended for at least partially blocking a passage, the at least one blocking element projects from the foot element transversely to the passage direction into the passage and thus at least partially blocks it. In the release position, the blocking element projects at least significantly less into the passage than in the blocking position or releases it completely. In particular in the case of turnstiles, there may be more than one blocking position and/or more than one release position, whereas in the case of a blocking element in the form of a pivoting bracket, only one blocking position and one release position are usual.

To detect people and goods in the passage area, the solutions mentioned below have been proposed:

Document EP 2 184 435 A1 shows a passageway system on whose blocking elements capacitive sensors are arranged.

Document EP 2 717 235 A1 proposes the integration of RFID antenna units in blocking elements of flat design.

Document DE 39 12 667 A1 proposes to arrange a remote data recognition device above the checkout aisle of a supermarket, which detects article numbers optically or by using radio.

DE 10 2008 020 953 B4 describes an entrance system with a monitoring device that monitors the position of at least one blocking element.

DE 199 35 024 A1 describes the detection of goods by quantity and type by receiving radio waves. The writing DE 2009 008 123 B4 describes a scan gate, the two side parts of which form a scan area and which is suitable for detecting RFID tags. FIG. 1 shows an arrangement of the scan gate followed by a passageway system, each of which has a foot element on the left and right of the passage and pivotable blocking elements arranged on the foot elements. The system shown in FIG. 1 makes it possible to release the passage by opening the passageway system after goods have been detected by the scan gate and paid for at a payment device.

The opening of a passageway system depending on the detection and payment of goods is further described in WO2018/013046A1.

The document DE 20 2017 100 982 U1 concerns a device for inventory monitoring, in particular of goods provided with transponders, and proposes for this purpose a device for entering and leaving a storage room and a goods passageway.

“AmazonGo” stores use entry and exit devices that interact with the customer's smartphone, which runs the “AmazonGo” app intended for this purpose.

Detection units used for the identifying detection of goods are devices that can distinguish items from other items. Devices that merely register the presence of an item, for example a light barrier or a motion sensor, are not detection units. Detection units use radio signals as information carriers in the case of RFID technology and light in the visible and infrared spectrum in the case of optical detection devices, i.e., cameras, barcode scanners, and QR code scanners.

There are disadvantages to using RFID tags. The tags are noticeably more expensive than printed barcodes or QR codes, and their detection does not succeed reliably if goods or goods containers reflect radio waves in an interfering manner. For this reason, barcodes and their optical detection with barcode scanners are still the standard, especially in discount retailing. Goods can also be optically detected on the basis of other visible surface features, so that not only readers but also cameras are suitable detection devices.

It is the task of the invention to further develop a passageway system of the type mentioned above in such a way that the identifying detection of goods placed on transport devices and moved horizontally with them is possible without RFID technology.

The solution of the problem is described in the characterizing part of claim 1.

The invention uses the fact that the at least one blocking element projects into the passage in the blocking position for the optical detection of goods in the area of the passage. The inventive solution is optimal for the detection of goods moved on platform carts or shopping carts with flat baskets. In the case of these transport devices, goods can be arranged side by side instead of one above the other, so that they are individually visible from the perspective of the detection unit and can be detected simultaneously.

The following advantageous embodiments are suitable for making the identifying detection of goods fast and reliable by means of the at least one optical detection device arranged on the at least one blocking element:

According to a first advantageous embodiment, the at least one optical detection device detects infrared light and the same or at least one other optical detection device detects visible light.

According to a second advantageous embodiment, the at least one optical detection device is a camera and/or a reader device. Suitable reader devices are in particular barcode scanners and QR code scanners.

According to a third advantageous embodiment, the detection unit is formed with a plurality of optical detection devices arranged at regular intervals.

According to a fourth advantageous embodiment, the detection unit is formed with alternately arranged cameras and reader devices.

According to a fifth advantageous embodiment, the at least one detection device is directed towards a detection space below and/or above the at least one blocking element when the at least one blocking element occupies the blocking position.

According to a sixth advantageous embodiment, the detection unit is configured to detect goods in motion relative to the detection unit from different perspectives in a continuous detection process. According to a seventh advantageous embodiment, data or signals generated by the detection unit are used not only to detect goods, but also by the control of the drive unit.

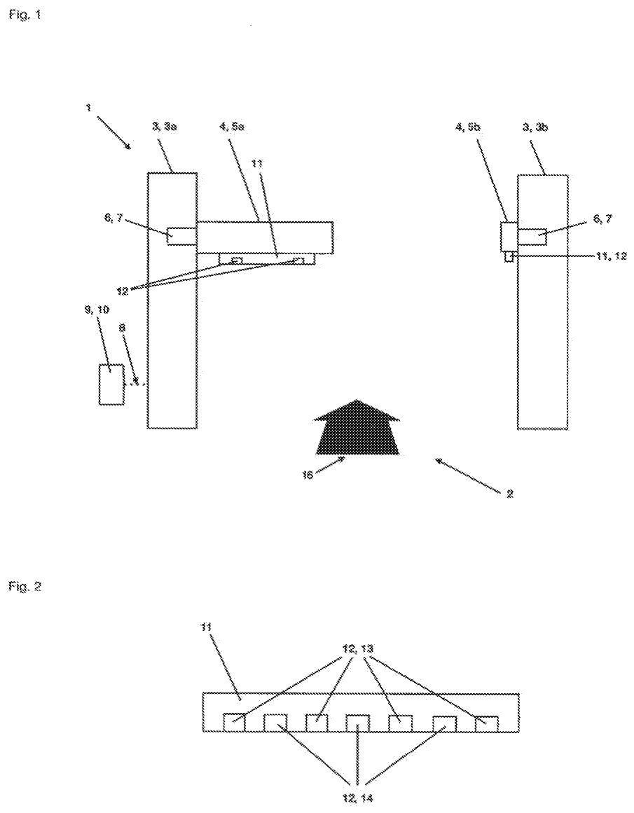

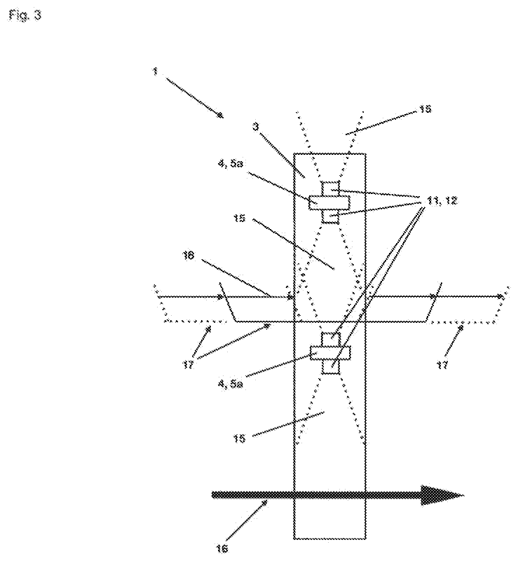

The invention will be explained in more detail below. The described advantageous embodiments of the invention can be seen from the combination of FIGS. 1-3. The first, second, third, and fourth advantageous embodiments are illustrated in particular by FIG. 2, and the fifth and sixth advantageous embodiments are illustrated in particular by FIG. 3.

FIG. 1 shows a passageway system 1 having at least one foot element 3, having at least one blocking element 4 which is mounted on the foot element 3 and can be moved between at least one blocking position 5a, intended for at least partially blocking a passage 2, and at least one release position 5b, which releases the passage 2, having a drive unit 6 which is used for moving the at least one blocking element 4, having a control 7 for the drive unit 6, having a detection unit 11, intended for the identifying detection of goods, and having interfaces 8 to a data processing unit 9 and optionally further components 10. At least one optical detection device 12 is arranged on the at least one blocking element 3, which is a component of the detection unit 11.

FIG. 1 shows an example of a passageway system 1 with a left and right foot element 3a, 3b laterally delimiting the passage 2 and with a blocking element 4 in each case. The passageway system can be configured differently, for example only one foot element 3 can be present and more than one blocking element 4 can be arranged on the one foot element 3, see FIG. 3.

The at least one detection device 12 may be installed within the detection unit 11, see FIG. 1 left and FIG. 2 or be exposed or protruding, see FIG. 1 right and FIG. 3. The detection unit 11 may itself consist of spatially separated parts that form a functional unit with respect to the identifying detection of goods, see FIG. 3.

FIG. 1 shows a passage direction 16. The orientation of the blocking element 4 in blocking position 5a of the at least one blocking element 4 is preferably at right angles to the passage direction, so that the blocking element 4 projects horizontally into the passage 2 from the side. The positioning of the detection unit 11 with optical detection devices 12 on the blocking element 4 is therefore optimal for the detection of goods that are arranged or moved below and/or above the blocking element 4 in blocking position 5a.

FIG. 2 shows a detection unit 11 with a plurality of optical detection devices 12, which are alternately arranged cameras 13 and reader devices 14. Such an elongated detection unit 11 integrates different and complementary optical detection techniques, for example computer vision and barcode scanning, and can detect the entire width of the passage 2, see FIG. 1, allowing identifying goods detection without using RFID technology.

FIG. 3 shows the passageway system 1 transverse to the passage direction 16. A foot element 3 can be seen, on which two blocking elements 4 are arranged as an example, both in blocking position 5a. Downwardly and upwardly directed detection units 11 with optical detection devices 12 are arranged on each of the blocking elements 4, which together form a detection unit 11 of the passageway system 1. Above and below the detection units 11, detection spaces 15 are shown delimited by conical dashed lines, which altogether form a detection space of the passageway system 1. Also shown is a goods container 17 in three different positions, preferably as a basket or platform forming part of a transport device movable on rollers, so that the goods container 17 is movable in a horizontal direction 18 below or above the detection units. If a transport device is pushed through the passage, this direction 18 is approximately identical to the passage direction 16. By coordinating the dimensions of the passageway system 1 and the transport device, it can be achieved that when the transport device is pushed into the passage 2, see FIG. 1, the goods being carried pass completely through the detection space 15 and are detected in a continuous detection process, so that identification of the goods is possible without RFID technology.

1. A passageway system with at least one foot element, with at least one blocking element which is mounted on the foot element and which is movable between at least one blocking position intended for at least partially blocking a passage and at least one release position releasing the passage, with a drive unit serving to move the at least one blocking element with a control of the drive unit, with a detection unit intended for the identifying detection of goods, and with interfaces to a data processing unit and optionally further components, characterized in that at least one optical detection device is arranged on the at least one blocking element and is a component of the detection unit.

2. Passageway system according to claim 1, characterized in that the at least one optical detection device detects infrared light and the same or at least one further optical detection device detects visible light.

3. Passageway system according to claim 1, characterized in that the at least one optical detection device is a camera and/or a reader device.

4. Passageway system according to claim 1, characterized in that the detection unit is formed with a plurality of optical detection devices arranged at regular intervals.

5. Passageway system according to claim 1, characterized in that the detection unit is formed with alternately arranged cameras and reader devices.

6. Passageway system according to claim 1, characterized in that the at least one detection device is directed towards a detection space below and/or above the at least one blocking element when the at least one blocking element assumes the blocking position.

7. Passageway system according to claim 1, characterized in that the detection unit is configured to detect goods in motion relative to the detection unit in a continuous detection process from different perspectives.

8. Passageway system according to claim 1, characterized in that data or signals generated by the detection unit are used by the control of the drive unit.
